(19) United States
(12) Patent Application Publication
(10) Pub. No.: US 2007/0046773 A1
(43) Pub. Date: Mar. 1, 2007

(54) Method for providing an output product service using a recyclable electronic capture device

(75) Inventor: John R. Fredlund, Rochester, NY (US)

Correspondence Address: Pamela R. Crocker;Patent Legal Staff, Eastman Kodak Company, 343 State Street, Rochester, NY, 14650-2201, US

(73) Assignee: Eastman Kodak Company

(21) Appl. No.: 11/217,879

(22) Filed: Sep. 1, 2005

(51) Int. Cl. H04N 7/14

(52) U.S. Cl. 348/14.01; 348/14.02

(57) ABSTRACT

A method for obtaining an output product/service by a user obtained from an electronic capture device. The method includes the steps of obtaining an electronic capture device by the user, obtaining digital data using the electronic capture device, communicating the captured digital data to a service provider over a communication network, the service provider providing an output product/service based on the digital data; and the service provider providing the output product/service to the user only after the electronic capture device is presented to an authorized location.

### FIELD OF THE INVENTION

The present invention relates to a digital data capture device that can be recycled.

### BACKGROUND OF THE INVENTION

There has been wide acceptance of digital capture device, for example, digital still cameras for capturing digital still images and digital video devices for capturing video. These devices are still relatively expensive and often become out dated within a year or two of purchase. In addition a user must take care when using these devices so as not to loose or break the device. Thus there is a need to provide relatively inexpensive devices for use by consumer. While there has been suggested the use of recyclable digital devices such as the Dakota Digital from Pure Digital Technologies, it often takes time in order to provide the output product or service to the user. There has also been a problem with users returning the device for recycling.

Thus, there is a need to provide relatively high quality digital data capture devices while also providing goods and service to the user in prompt manner and also providing the user with a motivational incentive encouraging the user to return the digital capture device for recycling.

### SUMMARY OF THE INVENTION

In accordance with one aspect of the present invention there is provided a method for obtaining an output product/service by a user obtained from an electronic capture device, comprising the steps of:

obtaining an electronic capture device by the user;

obtaining electronic data using the electronic capture device;

communicating the captured digital data to a service provider over a communication network;

the service provider providing an output product/service based on the digital data; and

the service provider providing the output product/service to the user only after the electronic capture device is presented to an authorized location.

In accordance with another aspect of the present invention there is provided a method for obtaining an output product/service by a user obtained from an electronic capture device, comprising the steps of:

obtaining an electronic capture device by the user;

obtaining digital data using the electronic capture device;

communicating the captured digital data to a service provider over a communication network; and

the service provider preparing an output product/service based on the digital data such that when the electronic captured device is returned to an authorized location the output product/service may be given to the user upon presentation of the electronic capture device to the authorized location.

In accordance with yet another aspect of the present invention there is provided a method for obtaining an output product/service by a user obtained from an electronic capture device, comprising the steps of:

obtaining an electronic capture device by the user;

obtaining digital data using the electronic capture device;

communicating the captured digital data to a service provider over a communication network;

the service provider providing an output product/service based on the digital data; and

the service provider providing the output product/service to the user at a first price when the electronic capture device is presented to an authorized location and at a second higher price if the electronic capture device is not returned to the authorized location.

These and other aspects, objects, features and advantages of the present invention will be more clearly understood and appreciated from a review of the following detailed description of the preferred embodiments and appended claims and by reference to the accompanying drawings.

### BRIEF DESCRIPTION OF THE DRAWINGS

In the detailed description of the preferred embodiments of the invention presented below, reference is made to the accompanying drawings in which:

FIG. 1 is diagram of a system for practicing the present invention;

FIG. 2 is a flow diagram illustrating one method of providing output product/services in accordance with the present invention;

FIG. 3 is a flow diagram illustrating a second method of providing output product/services in accordance with the present invention;

FIG. 4 is a flow diagram illustrating a third method of providing output product/services in accordance with the present invention; and

FIG. 5 is a flow diagram illustrating yet another method of providing output product/services in accordance with the present invention

### DETAILED DESCRIPTION OF THE INVENTION

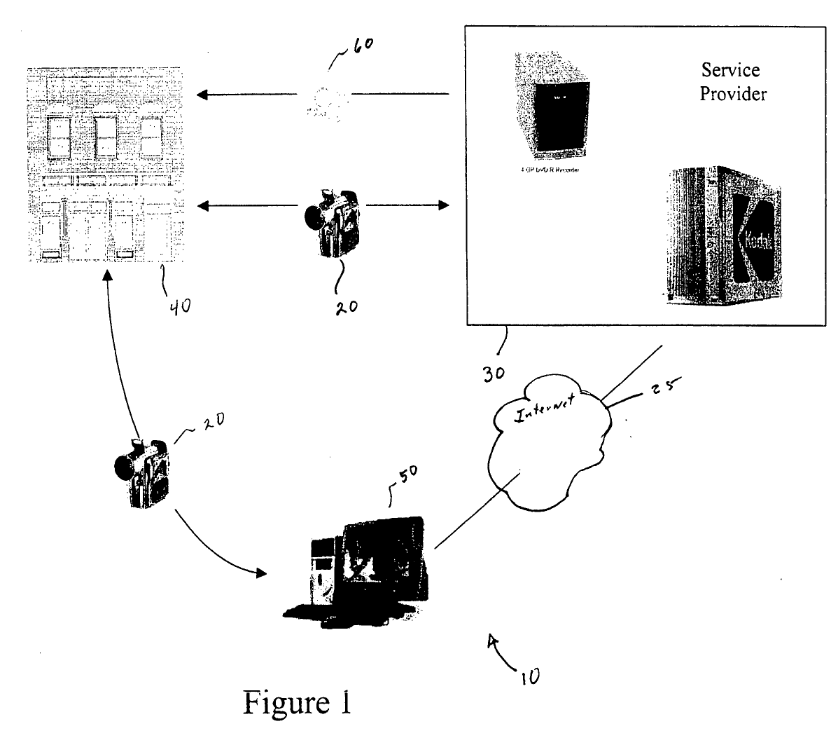

As system for use of a recyclable electronic capture device 20 is described. FIG. 1 shows system 10. An electronic capture device 20 is provided by service provider 30 to acquisition point 40 for purchase by the user. The user captures digital data with capture device 20. After capturing the digital data, the capture device 20 is connected to a network. In this case, capture device 20 is connected to a network 25 by means of network connection point/location 50, in this case a home computer. In the embodiment illustrated the network is the Internet, however, the network 25 may be any appropriate communication network that allows electronic communication between two devices. Service provider 30 uses data received from capture device 20 over the communication network 25 to create desired output 60, in this case a CD. Capture device 20 is returned to an authorized recycle point/location 40 in exchange for desired output 60. The authorized location 40 may be the same location as where the capture 20 was acquired or some other designated or affiliated location. The data captured by device 20 can be still or video images, audio, text, medical data, other data or any combination of data types.

The electronic capture device 20 is recyclable and is set up in such a manner that it can be operated for capturing a designated amount of digital data and/or for operation for a predetermined amount of time. For example, if the electronic capture device is a digital still camera, it may be set up to capture a predetermined number of digital images, e.g. 100, 200, 300 etc. Alternatively, if the electronic capture device is a digital video capture device, it may be set up to record for a predetermined amount of time, e.g. 1, 2 or 3 hours. Additionally, if the electronic capture device is a medical diagnostic tool, it may be set up to record the data necessary for a single diagnostic session with a single subject. The user may at the time of pick of the device may designate and pay for a predetermined of digital data or usage of the device 20.

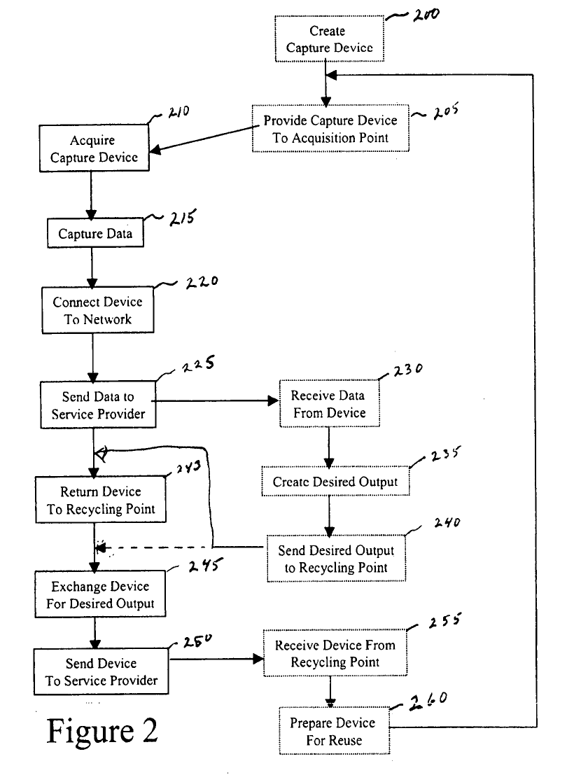

FIG. 2 is a flow chart of use of system 10. In step 200, the service provider creates capture device 20. In step 205, the service provider 30 provides capture device 20 to acquisition point/location 40, for example a retail establishment. The service provider 30 and acquisition location may be separate as illustrated or may be the same entity. The user acquires capture device 20 at acquisition point 40 in step 210. The user captures data using capture device 20 in step 215. In step 220, capture device 20 is connected to a network for establishing a communication link with a designated location for transmission of data thereto. In FIG. 1, capture device 20 is shown connected through network connection point 50 over network 25 to service provider 30. However, there are many other ways to connect to a network such as plugging capture device 20 into a phone line, or by using a cellular phone or Wi-Fi connection provided in device 20. Additionally, the device 20 need not be actually connected to the network since if network connection point 50 is a home computer or like device, the computer 50 can act as a proxy for device 20. Data can be transferred over the network 25 even when device 20 is not connected directly to network 25.

Continuing with FIG. 2, step 225 shows data being sent to service provider 30 over communication network 25. The data is received in step 230. Service provider 30 creates desired output 60 from the data received in step 235. Step 240 shows desired output 60 being sent to recycling point 70. It is to be understood that the output may be any desired product or service, for example but not limited to, hard copy prints, t-shirts, posters, CD (compact discs) or mugs bearing images captured by the capture device 20, audio and/or video CD, or any other memory device product or service that can retain the captured images, video and/or audio captured by the electronic capture device 20. The present invention allows for the preparation of the desired output prior to return of the device 20 to the recycle point at step 243. In this way it is possible to have the output at the recycle point/center 70 when the device 20 is returned. Recycling point/location 70 may be the same location as acquisition point/location 40. In step 245, the user exchanges device 20 for desired output 60. This may not be an even exchange in that the user may have to pay a sum in addition to returning capture device 20 to obtain desired output 20. Step 250 shows device 20 being transferred to service provider 30. In step 255, service provider 30 receives device 20, and in step 260, service provider 30 prepares device 20 for reuse. The cycle repeats at this point.

If the user wishes to pick up the output prior to returning the device 20 at the recycling location 70, a higher fee may be associated with the pick of the output. A credit or rebate may be later given to the user upon return of the device 20 to the recycling center 70. Alternatively, the output may be provided only after return of the capture device 20 to the recycling center 70. In certain cases the recycling center 70 may be able to prepare the output immediately upon return of the device 20 so that the customer need not wait very long in order to receive the output.

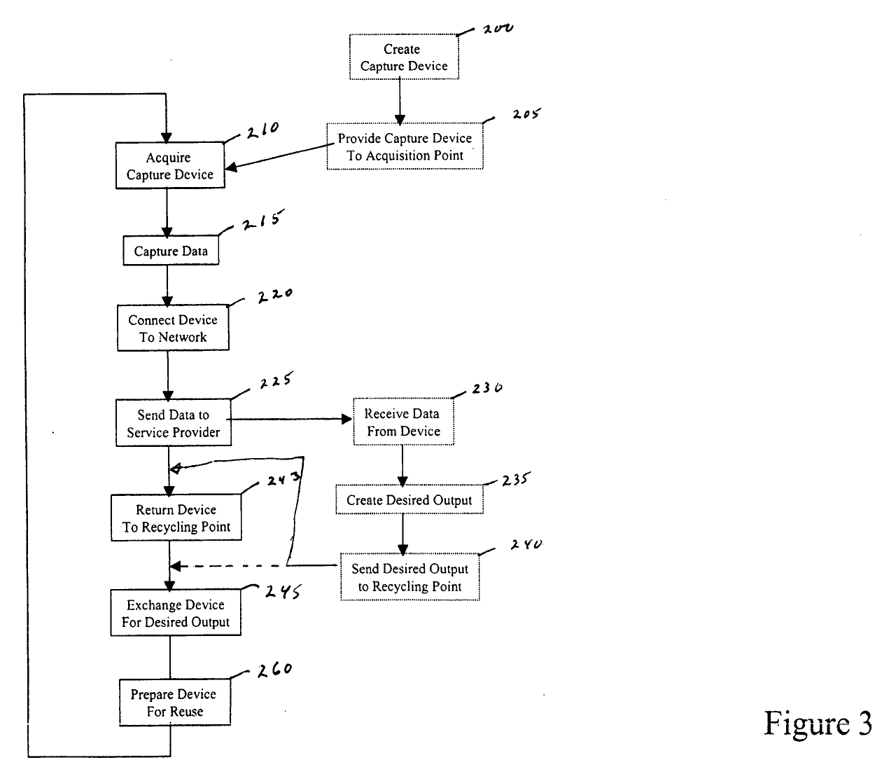

FIG. 3 shows a use of system 10 where the capture device is not returned to the service provider for preparation for reuse, like numbers indicating like steps as previously discussed. In step 200, the service provider prepares capture device 20 for use. In step 205, the service provider 30 provides capture device 20 to acquisition point 40. The user acquires capture device 20 at acquisition point 40 in step 210. The user captures data using capture device 20 in step 215. In step 220, capture device 20 is connected to a network. Step 225 shows data being sent to service provider 30. The data is received in step 230. Service provider 30 creates desired output 60 from the data received in step 235. Step 240 shows desired output 60 being sent to recycling point 70. Recycling point 70 may be the same location as acquisition point 40. In step 245, the user exchanges device 20 for desired output 60. In step 260, recycling point 70 prepares device 20 for reuse. The cycle repeats at this point. Note that preparation for reuse need only be erasing data and ensuring that power is adequate for the next cycle. In this case, recycling point 70 need not have access to data on the device, and the recycling procedure can be very simple.

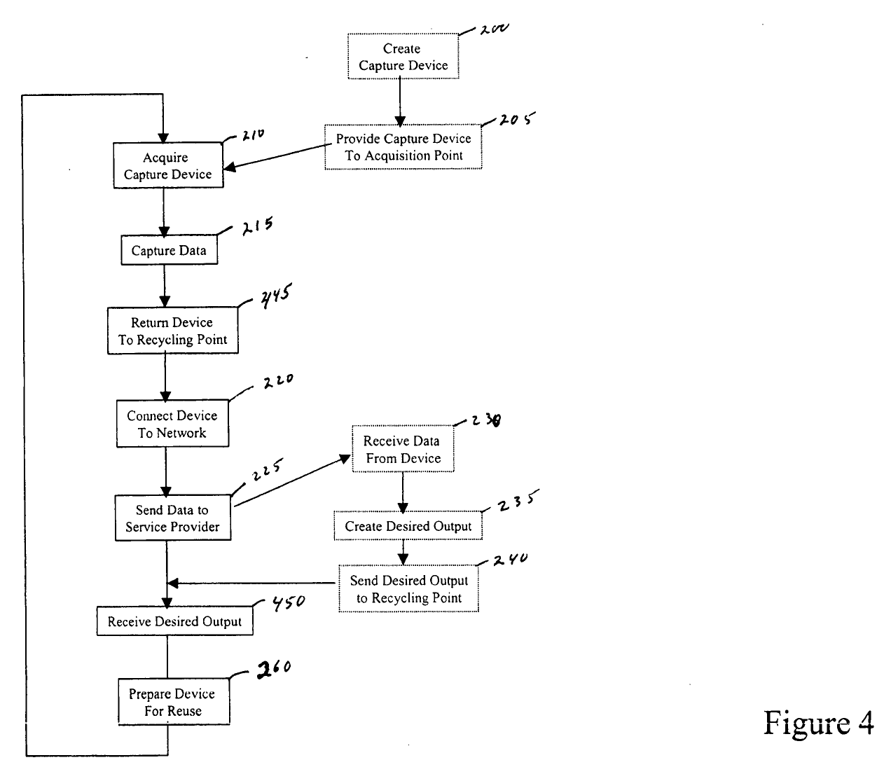

FIG. 4 shows a use of system 10 where the capture device is not returned to the service provider for preparation for reuse, and where connection to the network is done at the recycling point 70. Here again, like numerals indicating like steps as previously described. In step 200, the service provider prepares capture device 20 for use. In step 205, the service provider 30 provides capture device 20 to acquisition point 40. The user acquires capture device 20 at acquisition point 40 in step 210. The user captures data using capture device 20 in step 215. In step 445, the user returns device 20 to recycling point 70. In step 220, capture device 20 is connected to a network. Step 225 shows data being sent to service provider 30. The data is received in step 230. Service provider 30 creates desired output 60 from the data received in step 235. Step 240 shows desired output 60 being sent to recycling point 70. In step 450, the user receives desired output 60. In step 260, recycling point 70 prepares device 20 for reuse. The cycle repeats at this point. The use of system 10 in this fashion is preferred when medical diagnostic devices are employed. The device may be very expensive, and it becomes very important that the device is returned. The motivational incentive encouraging the user to return the digital capture device for recycling is the diagnosis or plan for treatment. Additionally, in regions of the world where network connections are unreliable, expensive or non-existent for users, the use shown in FIG. 4 enables connection at the acquisition point which can afford the network connection.

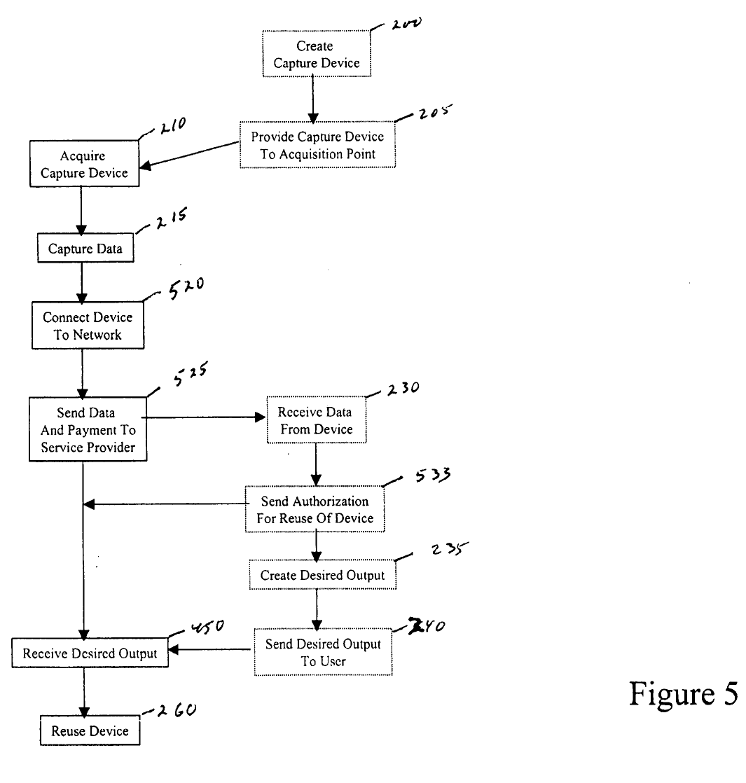

FIG. 5 shows a use of system 10 where the capture device 20 is not returned to the service provider for preparation for reuse, and where connection to the network 25 is done at network connection point 50. Like numerals indicating like steps as previously discussed. A home computer is used as an example of a connection point. Network connection point 50 could be any user selected location that allows network connection. If the connection to the network 25 is done by radio frequency means, the connection point can be anywhere coverage is provided by the network 25. In step 200, the service provider creates capture device 20. In step 205, the service provider 30 provides capture device 20 to acquisition point/location 40. The user acquires capture device 20 at acquisition point 40 in step 210. The user captures data using capture device 20 in step 215. In step 520, capture device 20 is connected to network 25. Step 525 shows data being sent to service provider 30 over the network 25. This data includes data captured by device 20 and also payment information so that device 20 can be authorized for further use. The data is received in step 230. In step 533, service provider 30 sends authorization for reuse to device 20. This authorization for reuse can take the form of a password or number that the programming of device 20 must have to continue its desired function. Service provider 30 creates desired output 60 from the data received in step 230. Step 240 shows desired output 60 being sent to a receiving point designated by the user. For the purposes of this example, the receiving point is the location of the network connection point 50, but this need not be the case. The user can specify another location for delivery of desired output 60. In step 450, the user receives desired output 60. The cycle repeats at this point.

In the above descriptions, the data captured by capture device 20 may be used in many ways. By way of example, when device 20 is a One Time Use Digital Video Camera, the data sent to service provider 30 is the captured video data. In this case, desired output 60 is some type of media such as a DVD that contains the video files that the user can view. The data sent to service provider 30 is formatted appropriately for a DVD and written to disk. The data is transcoded from one format to another, such as from MPEG4 to MPEG2. This transformation provides added utility since MPEG2 files can be played by all DVD players. The capture device may be less complicated and less expensive because the transformation is done by the service provider. Additionally, the service provider may improve enhancements to the data. These enhancements could include processing with an improved processing path that is not easily implemented in the device due to the complexity of the path. These enhancements may also include camera-specific improvements such as sensor defect correction in a manner described by Maurinus in U.S. Pat. No. 5,606,365.

By way of another example, when device 20 is a medical diagnostic tool such as a blood analyzer, the data sent to service provider 30 is the result of blood testing by device 20. Service provider 30 uses this data to determine the condition of the tested individual and determine the appropriate treatment. In this case, desired output 60 can be a drug related to a diagnosed condition, a prescription for a drug related to a diagnosed condition, a recommendation for further testing and analysis or a plan for treatment. The data captured by device 20 may or may not be included with the desired output that is returned to the user. The utility provided by the system is the interpretation of diagnostic data to create a diagnosis or treatment program. The service provider may provide the interpretation by means of computer analysis, or medical personnel may interpret the data.

Service provider 30 must know where to send desired output 60. There are many options that can be used to determine this destination. The user can key the ID number or address of the retail location into capture device 20 before transmission of data to the finisher. The ID number or address is transmitted with otherwise captured data. If device 20 is capable of capturing images, the user can capture an image of an ID or address of recycling point/location 70 with device 20. Further capture is not enabled until this step is completed and verified by the device 20. The ID number or address is transmitted with captured data. Service provider 30 may track ID numbers of capture devices to different retail locations. The ID number is transmitted with captured data. Service provider 30 has a database that identifies the retail location corresponding to the ID number. This is problematic if the user returns the device to a retail location other than the retail location where the device was originally acquired. The user can key in zip code and device 20 provides retail location options for selection. Within a zip code there may be more than one retail location, hence the selection. There may be no ID number for the retail location. When the device is returned, captured data corresponding to the device ID number is sent to the retail location and written to media at the retail location. In this case, desired output 60 is either resident at the retail location, such as in the case of a drug store providing a drug in response to a prescription sent from service provider 30, or is created at the retail location, such as in the case of a store enabled with a DVD writer on site and where the digital data captured by device 20 are video files. The retail location uses a network connection to access the result of the analysis of captured data or downloads the data to create or select desired output 60.

Data sent to service provider 30 in steps 225 and 525 may be encrypted or in a non-standard format to discourage unauthorized use. Additionally, capture device 20 may not be enabled to send data until a particular string of data or key is received from the service provider.

Once digital data has been received by service provider 30, orders for products and services using said digital data may be obtained by service provider 30.

Note that service provider 30 can indicate where and when desired output 60 will be provided. When capture device 20 has been connected, service provider 30 can transfer data to capture device 20 that can be used to notify the user of pickup time and location after completion of data transfer to service provider 30. Service provider 30 can indicate where and when desired output 60 will be provided.

The invention has been described in detail with particular reference to certain preferred embodiments thereof, but it will be understood that variations and modifications can be effected within the scope of the invention, the present invention being defined by the claims set forth herein.

### PARTS LIST

10 system
20 electronic capture device
25 network
30 service provider
40 point/location
50 point/location
60 output
70 recycling point
200 step
205 step
210 step
215 step
220 step
225 step
230 step
235 step
240 step
243 step
245 step
250 step
255 step
260 step
445 step
450 step
520 step
525 step
533 step

1. A method for obtaining an output product/service by a user obtained from an electronic capture device, comprising the steps of:
obtaining an electronic capture device by said user;
obtaining digital data using said electronic capture device;
communicating said captured digital data to a service provider over a communication network;
said service provider providing an output product/service based on said digital data; and
said service provider providing said output product/service to said user only after said electronic capture device is presented to an authorized location.

2. A method according to claim 1 wherein said electronic capture device comprises a digital video capture device.

3. A method according to claim 2 wherein said digital video capture device also captures sound.

4. A method according to claim 1 wherein said electronic capture device comprises a medical monitoring/analyzing device.

5. A method according to claim 1 wherein said authorized location is a retail establishment that provided said electronic capture device to said user.

6. A method according to claim 5 wherein said service provider and said retail establishment are the same entity.

7. A method according to claim 1 wherein said user causes said communication of said capture digital data to said service provider.

8. A method according to claim 1 wherein said authorized location takes said electronic capture device and refurbishes the electronic device so that it can be provided to a second customer.

9. A method according to claim 1 wherein the designated authorized location modifies said electronic capture device such that it can again be used by said user.

10. A method according to claim 1 wherein said authorized location comprises a kiosk that can be used by said user for transmitting said digital data to said service provider and for ordering of said output products/services.

11. A method according to claim 1 wherein said device is no longer functional until it is refurbished by an authorized location.

12. A method according to claim 1 wherein said user pays in advance a sufficient amount of money such that upon communicating of said captured digital data to said service provider, that service provider will automatically start the procedure for producing designated output products/services.

13. A method according to claim 1 wherein said service provider transforms, improves or interprets received digital data to provide said output product/service

14. A method according to claim 1 wherein said electronic capture device sends captured digital data upon receipt of a key received from the service provider.

15. A method according to claim 1 further comprising placing orders for products and services using said digital data from said service provider after digital data has been received from said electronic capture device.

16. A method for obtaining an output product/service by a user obtained from an electronic capture device comprising the steps of:
obtaining an electronic capture device by said user;
obtaining digital data using said electronic capture device;
communicating said captured digital data to a service provider over a communication network; and
said service provider preparing an output product/service based on said digital data such that when said electronic captured device is returned to an authorized location said output product/service may be given to said user upon presentation of said electronic capture device to said authorized location.

17. A method according to claim 16 wherein said electronic capture device comprises a digital video capture device.

18. A method according to claim 17 wherein said digital video capture device captures sound.

19. A method according to claim 16 wherein said electronic capture device comprises a medical monitoring/analyzing device.

20. A method according to claim 16 wherein said authorized location is a retail establishment that provided said electronic capture device to said user.

21. A method according to claim 20 wherein said service provider and said retail establishment are the same entity.

22. A method according to claim 16 wherein said user causes said communication of said capture digital data to said service provider.

23. A method according to claim 16 wherein said authorized location takes said electronic capture device and refurbishes the electronic device so that it can be provided to a second customer.

24. A method according to claim 16 wherein the designated authorized location modifies said electronic capture device such that it can again be used by said user.

25. A method according to claim 16 wherein said authorized location comprises a kiosk that can be used by said user for transmitting said digital data to said service provider and for ordering of said output products/services.

26. A method according to claim 16 wherein said device is no longer functional until it is refurbished by an authorized location.

27. A method according to claim 16 wherein said user pays in advance a sufficient amount of money such that upon communicating of said captured digital data to said service provider, that service provider will automatically start the procedure for producing designated output products/services.

28. A method for obtaining an output product/service by a user obtained from an electronic capture device, comprising the steps of:
obtaining an electronic capture device by said user;
obtaining digital data using said electronic capture device;
communicating said captured digital data to a service provider over a communication network;
said service provider providing an output product/service based on said digital data; and
said service provider providing said output product/service to said user at a first price when said electronic capture device is presented to an authorized location and at a second higher price if said electronic capture device is not returned to said authorized location.

29. The method according to claim 28 wherein a credit is provided to said user when said electronic capture device is later returned to said authorized location.
